(19) United States
(12) Patent Application Publication
(10) Pub. No.: US 2010/0192786 A1
(43) Pub. Date: Aug. 5, 2010

(54) COMPACTING MACHINE

(75) Inventor: Chris O'Brien, Sylvania (AU)

Correspondence Address: K&L Gates LLP;IP Docketing, 630 HANSEN WAY, PALO ALTO, CA, 94304, US

(73) Assignee: HUNGRY GIANT HOLDINGS PTY LTD., Cambeltown (AU)

(21) Appl. No.: 12/601,807

(22) PCT Filed: May 20, 2008
(86) PCT No.: PCT/AU2008/000709

§ 371 Date: Nov. 24, 2009

(30) Foreign Application Priority Data
May 25, 2007 (AU) 2007902817

(51) Int. Cl. B30B 15/26; B30B 15/00

(52) U.S. Cl. 100/43; 100/94; 100/102

(57) ABSTRACT

A compacting machine (10) includes a support structure (12). A feed hopper (14) is carried by the support structure (12) the feed hopper (14) being configured to receive waste material to be compacted, the feed hopper (14) having a discharge opening (20). A comminuting station (18) is arranged downstream of, and in communication with, the discharge opening (20) of the feed hopper (14) to comminute material received from the feed hopper (14) into granules of a predetermined size A compacting station (22) is arranged downstream of the comminuting station (18), the compacting station (22) defining a compacting station (58) in which granules discharged from the comminuting station (18) are compacted. The compacting station (22) further includes a compacting member (50) treated to reduce friction and heat generation as the material is compacted in the compacting zone (58).

### CROSS-REFERENCE TO RELATED APPLICATIONS

The present application claims priority from Australian Provisional Patent Application No 2007902817 filed on May 25, 2007, the contents of which are incorporated herein by reference in their entirety.

### FIELD OF THE INVENTION

This invention relates, generally, to the compacting of materials and, more particularly, to a compacting machine for compacting waste materials. The machine has particular, but not necessarily exclusive, application in the compacting of waste, foamed materials.

### BACKGROUND TO THE INVENTION

Goods of value, such as, for example, white goods are packed in protective material for shipping to protect the goods against damage. At the point of sale, the goods are stripped of their protective material. This protective material needs to be disposed of. To fulfil its protective requirement, the material is generally voluminous in nature. This often arises because the material is a foamed material such as expanded polystyrene (EPS).

Plastics materials such as EPS are not bio-degradable and, when disposed of, take up an excessive amount of space in landfill sites or other refuse tips. In addition, because of the lightweight nature of the material, it can quite easily be blown away by prevailing winds resulting in increased levels of pollution.

### SUMMARY OF THE INVENTION

According to the invention, there is provided a compacting machine which includes:

a support structure;

a feed hopper carried by the support structure, the feed hopper being configured to receive waste material to be compacted, the feed hopper having a discharge opening;

a comminuting station arranged downstream of, and in communication with, the discharge opening of the feed hopper to comminute material received from the feed hopper into granules of a predetermined size; and

a compacting station arranged downstream of the comminuting station, the compacting zone defining a compacting zone in which granules, discharged from the comminuting station, are compacted and the compacting station further including a compacting member treated to reduce friction and heat generation as the material is compacted in the compacting zone.

The support structure may be in the form of a housing on which the feed hopper is mounted, the housing supporting the comminuting station and the compacting station. The housing may have an access door for enabling access to be gained to the feed hopper, the access door including an interlock so that the machine is inoperable unless the door is closed.

The comminuting station may comprise a plurality of comminuting elements. Each comminuting element may be in the form of a blade assembly carrying a plurality, preferably a pair, of arcuate, outwardly extending blades mounted on a boss, each comminuting element being carried on a shaft. Further, the comminuting station may comprise at least two spaced, counter-rotating shafts, each carrying a plurality of comminuting elements in longitudinally spaced relationship with the comminuting elements of adjacent shafts being interdigitated with respect to each other.

Each comminuting element may also carry grabbing members which serve to grab material to be compacted to be drawn into position to be granulated by the comminuting elements. Each grabbing member may be in the form of a finger which extends parallel to a longitudinal axis of its associated shaft. Further, the grabbing members may be arranged on their associated comminuting elements in staggered relationship relative to one another along the shaft to assist in drawing material into position between the comminuting elements to effect granulation of the material.

Each side wall of the comminuting station may include inwardly directed protrusions to direct material to be granulated into position between the comminuting elements.

The comminuting station may further include a discriminator which passes granulated material smaller than a predetermined size and retains material in the comminuting station larger than the predetermined size. For example, the discriminator may be in the form of a filter having apertures which pass material of a size less than approximately 20 mm and, optimally, about 18 mm while retaining material greater than that size in the comminuting station.

The compacting member may comprise a rotary element which rotatably drives material to be compacted into the compacting zone. The rotary element may be in the form of an auger having a helical flight mounted about a rotatable shaft.

At a downstream end of the auger, the flight my terminate flush with a downstream end of the shaft. This ensures that, when material is being compacted, any one part of the auger only once touches that material. This also serves to minimise heat generation in the compacting procedure. The auger may be coated with a material which reduces friction and minimises heat generation. The coating material is, preferably, a suitable ceramic material. The ceramic material may be a sprayable ceramic material. The ceramic material may have a Shore Hardness, in the D Scale, of approximately 80 to 90 and, optimally, about 85. Further, the ceramic material may be able to operate up to a maximum operating surface temperature of approximately 95° C.

The rotary element may be arranged upstream of the compacting zone and in which a downstream end of the compacting zone is closed off by a pressure applying member. The pressure applying member may be in the form of a pivoted wing closing off an outlet opening of the compacting zone. The pivoted wing may be biased into an operative position in which it exerts pressure on compacted material being extruded through the outlet opening.

The pivoted wing may be biased into its operative position by a fluid operable strut.

The machine may include a control arrangement. The control arrangement may include the interlock associated with the access door. Further, the control arrangement may include an over temperature sensor. The over temperature sensor may be mounted at the downstream end of the auger, in the compacting zone so that, when an over temperature condition is sensed, operation of the machine ceases.

Additionally, the control arrangement may include a sensor for sensing the state of fill of the hopper and to deactivate the operation of the machine if the hopper is empty.

The invention extends also to an accessory for a compacting machine, the accessory comprising an auger having a helical flight mounted about a rotatable shaft, the flight terminating flush with a downstream end of the shaft.

The auger may be coated with a material which reduced friction and minimises heat generation.

### BRIEF DESCRIPTION OF DRAWINGS

An embodiment of the invention is now described by way of example with reference to the accompanying drawings in which:

FIG. 1 shows a three-dimensional view of an embodiment of a compacting machine;

FIG. 2 shows a three-dimensional view of a comminuting station of the machine;

FIG. 3 shows a sectional, end view of a part of the machine;

FIG. 4 shows a schematic, sectional side view of the part of the machine;

FIG. 5 shows a plan view of the comminuting station of the machine;

FIG. 6 shows a sectional side view of a part of the comminuting station of the machine;

FIG. 7 shows a sectional end view of a part of the comminuting station of the machine;

FIG. 8 shows a plan view of a discriminator of the comminuting station of the machine;

FIG. 9 shows an end view of the discriminator;

FIG. 10 shows a side view of a part of a compacting station of the machine;

FIG. 11 shows a three-dimensional, schematic view of a part of an auger of the compacting station of the machine; and

FIGS. 12 and 13 show wiring diagrams of the compacting machine.

### DETAILED DESCRIPTION OF EXEMPLARY EMBODIMENT

In the drawings, reference numeral 10 generally designates an embodiment of a compacting machine. The compacting machine 10 comprises a support structure 12 on which a feed hopper 14 is mounted. An access opening of the feed hopper 14 is closed off by an access door 16.

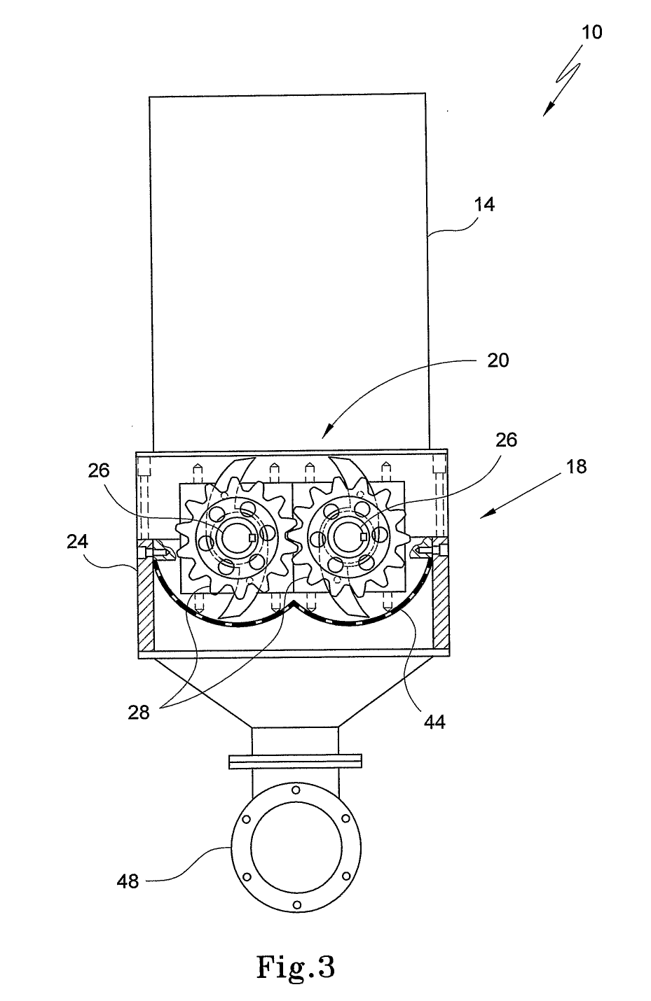

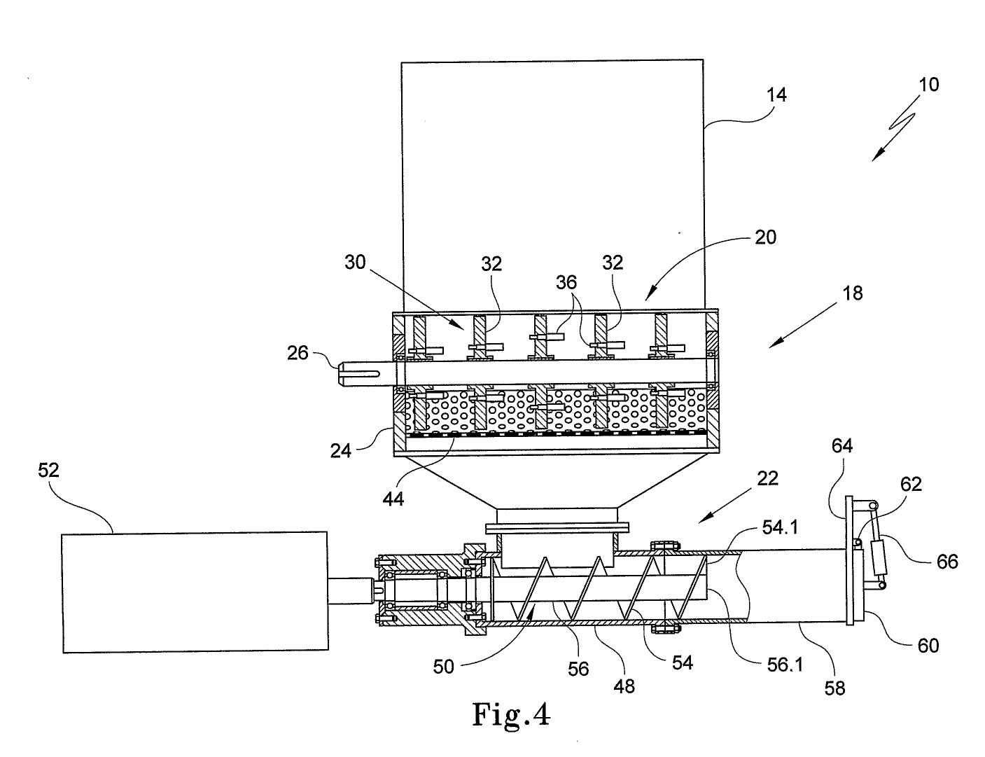

A comminuting station 18 (FIGS. 3 and 4) is arranged below the feed hopper 14. The feed hopper 14 has a discharge opening 20 opening into the comminuting station 18. A compacting station 22 is arranged downstream of the comminuting station 18.

The comminuting station 18 comprises a receptacle 24 on which the feed hopper 14 is mounted. A pair of counter-rotating shafts 26 is mounted within the receptacle 24. The counter-rotating shafts 26 engage via meshing gears 28 (FIG. 3).

Each counter-rotating shaft 26 carries a plurality of longitudinally spaced comminuting elements 30. More particularly, each comminuting element 30 comprises a pair of opposed, arcuate comminuting blades 32 mounted on a boss 34. Each blade 32 supports a grabbing member in the form of a finger 36 which extends parallel to a rotational or longitudinal access of its associated shaft 26.

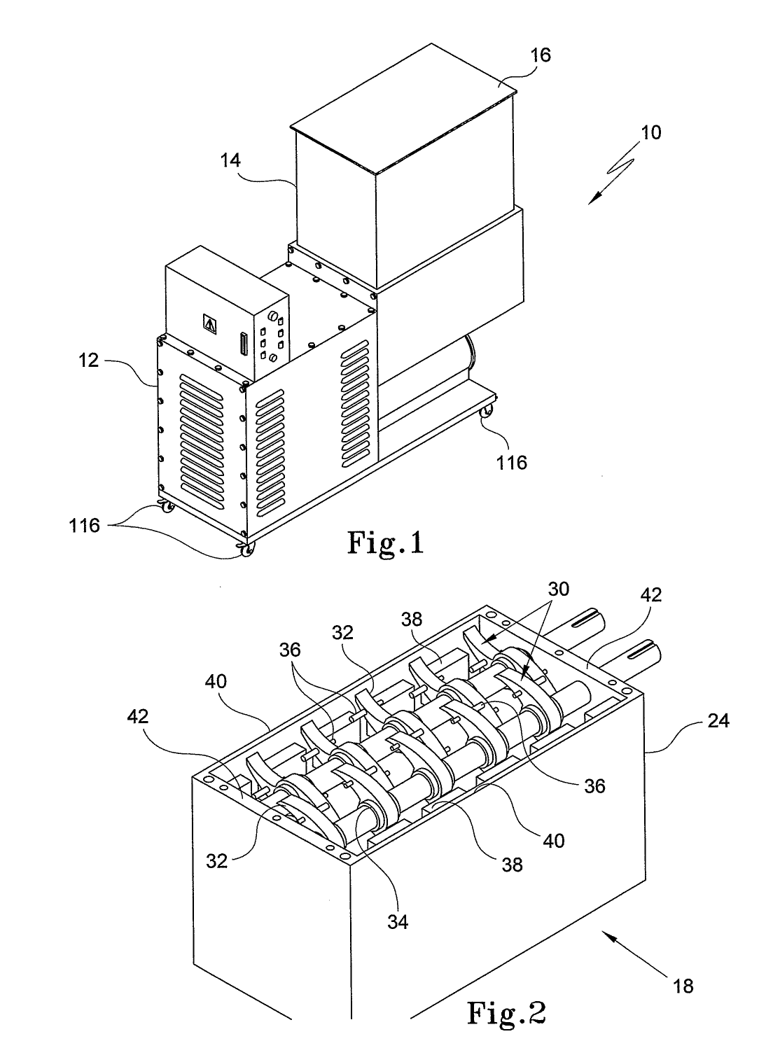

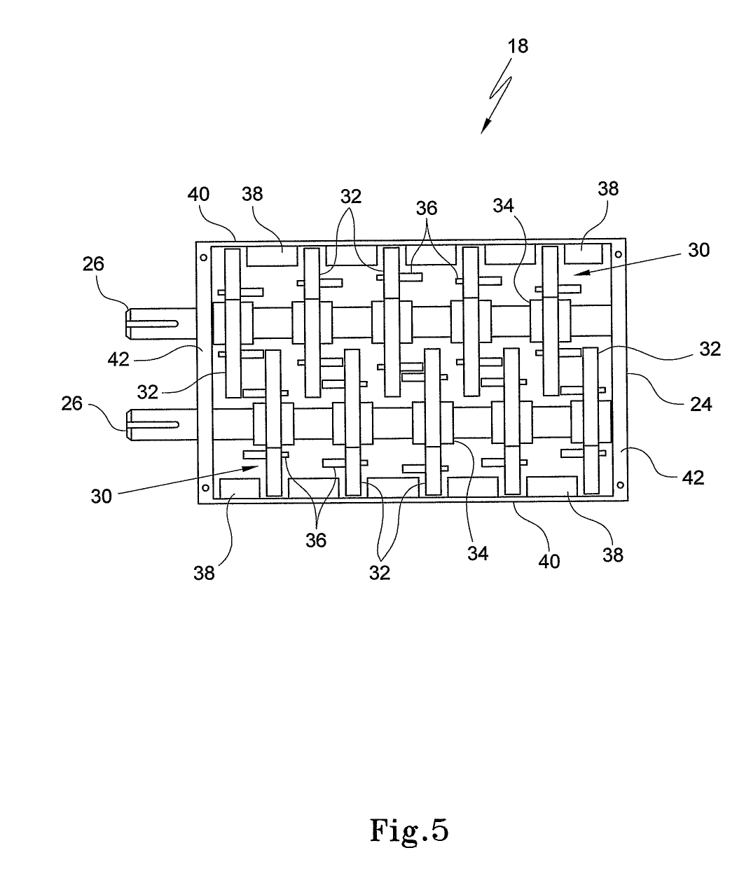

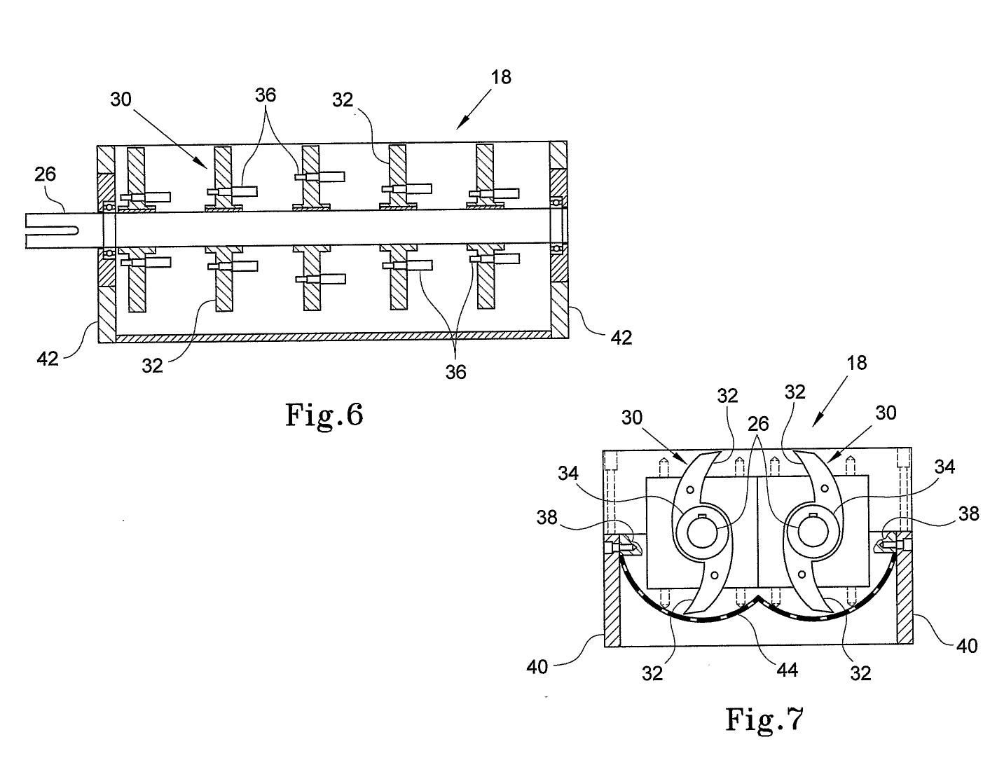

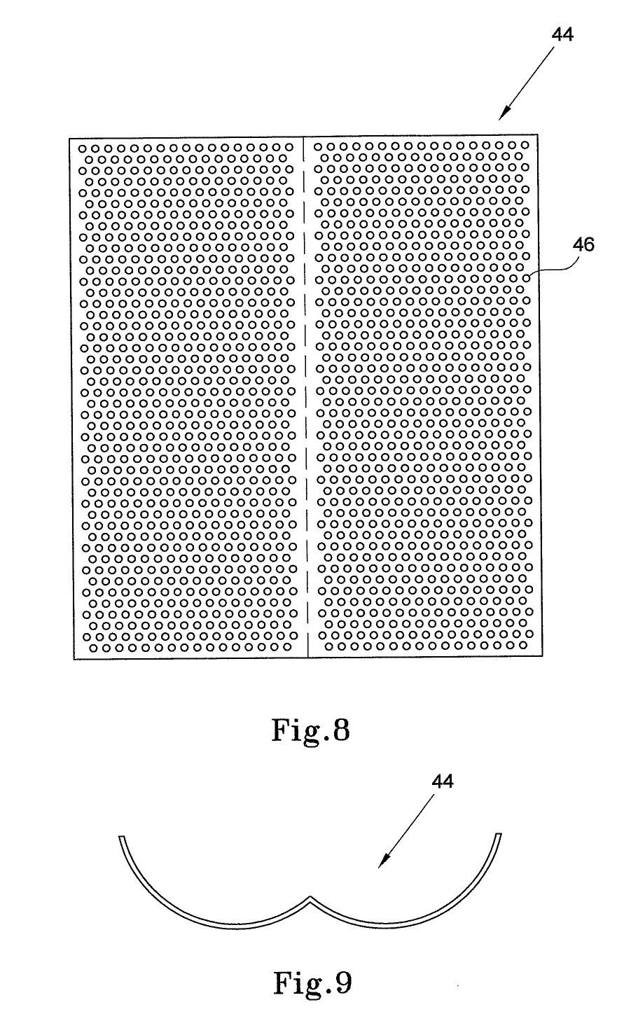

As illustrated most clearly in FIGS. 2 and 5 of the drawings, the comminuting elements 30 of one shaft 26 are interdigitated with respect to the comminuting elements 30 of the adjacent shaft 26. In addition, the fingers 36 mounted on the blades 32 of the comminuting elements 30 are staggered with respect to each other to assist in grabbing material to be comminuted and urging it between the blades 32 of the comminuting elements 30.

Inwardly directed protrusions 38 (FIG. 5) are arranged on each side wall 40 of the receptacle 24 of the comminuting station 18. These protrusions 38 are arranged intermediate the comminuting elements 30 or a comminuting element 30 and an end wall 42 of the receptacle 24. The protrusions 40 further serve to urge the material to be comminuted between the blades 32 of the comminuting elements 30.

The comminuting station 24 includes a discriminator or filter 44 arranged beneath the comminuting elements 30. The filter 44, when viewed end on, has a rounded substantially W-shape and is positioned below the blades 32 of the comminuting elements 30 so that any material resting on the surface of the filter 44, which is too large to pass through the filter 44, is swept up by the blades 32 of the comminuting elements 30 to be granulated further. The tips of the blades 32 are shaped to assist in sweeping up the material from the filter 44.

The filter 44 has apertures 46 of predetermined dimensions which pass material of a particular size but which block the passage of granular material having a size greater than the diameter of the apertures 46. Typically, the apertures 46 have a diameter of less than 20 mm, optimally, about 18 mm to pass granulated material of that size. The filter 44 is of expanded metal mesh or of punched metal sheet.

The compacting station 22 comprises a sub-housing 48 in which a compacting member in the form of a rotary screw or auger 50 is rotatably mounted to be rotatably driven by a motor 52 (FIG. 4). The auger 50 has a helical flight 54 mounted fast with a shaft 56. The flight 54 and the shaft 56 are coated with a low-friction coating. More particularly, the coating is of a ceramic material. Typically, the ceramic material is a spray-on ceramic material having a Shore Hardness, in the D Scale, of approximately 85. The ceramic coating results in a low-friction finish of the flight 54 and limits heat generation arising due to friction. An example of the ceramic material is that sold under the trade name “Ultraglide” and is a sprayable ceramic material available from New Ceramic Coatings Pty Ltd, PO Box 2159, Gateshead Business Centre, NSW, 2290, Australia.

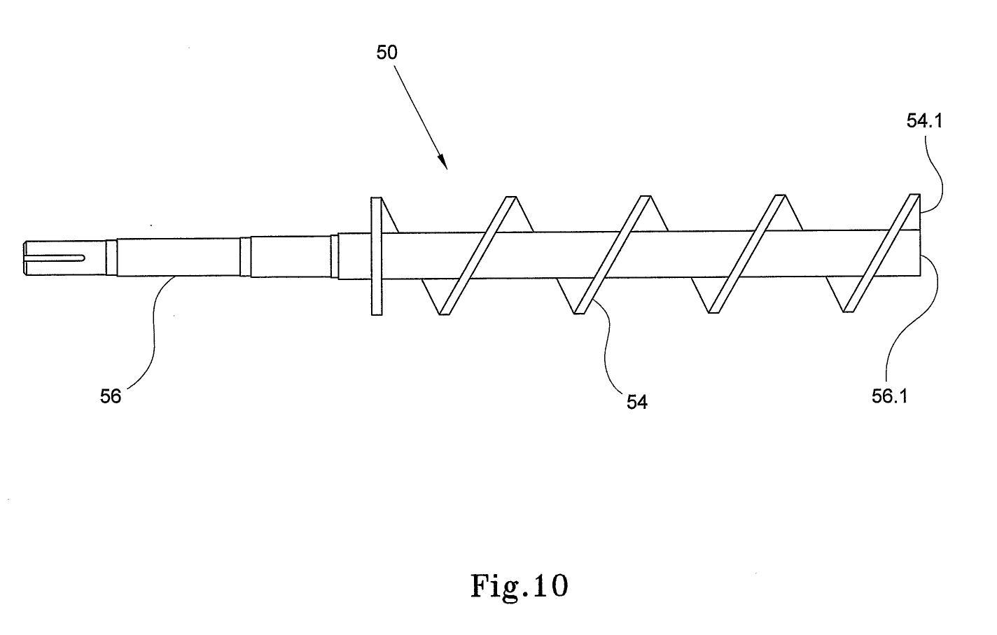

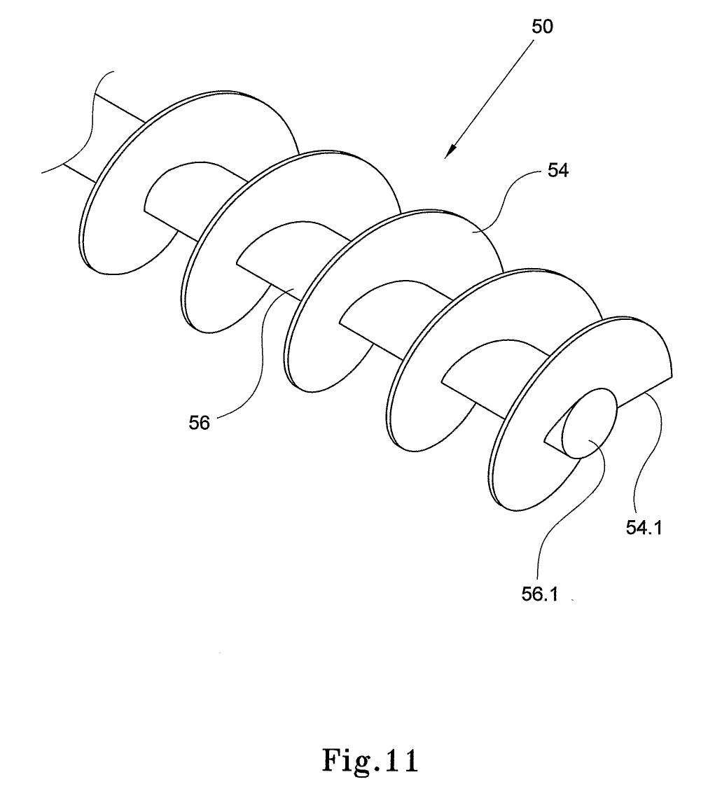

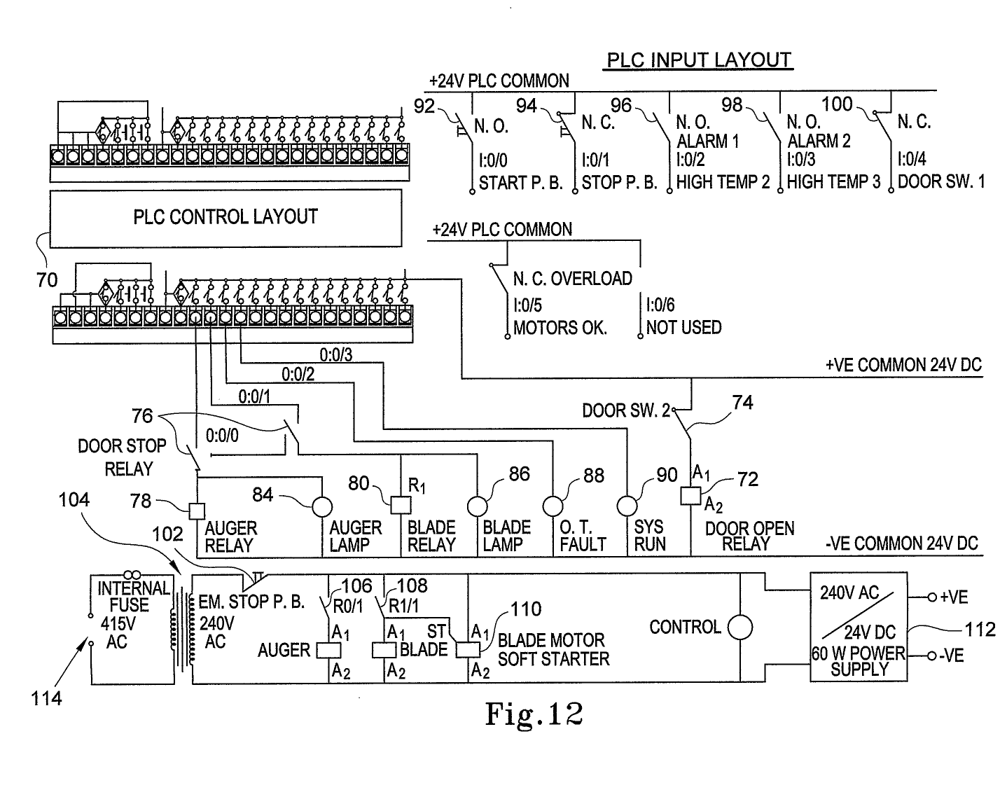

To further minimise heat generation, a downstream end 54.1 of the flight terminates flush with a downstream end 56.1 of the shaft 56 as shown in FIG. 10 of the drawings and as illustrated schematically in FIG. 11 of the drawings. This ensures that, when granulated material is passed along by the auger 50 and compacted, any one part of the auger 50 only once touches that material. This serves further to minimise heat generation during the compacting procedure.

The auger 50 feeds material into a compacting zone, or compacting chamber, 58 arranged downstream of the auger 50. The compacting chamber 58 is a cylindrical chamber and is closed off by a pressure applying means in the form of a wing member 60. The wing member 60 is hinged at 62 to a frame 64. The frame 64 supports a biasing device in the form of a fluid-operated strut 66 which is pivotally connected to the frame 64 and to the wing member 60. The arrangement is such that, even when the wing member is in a fully open position, it is angled slightly downwardly relative to the horizontal so that, as compacted material is extruded outwardly from the compacting chamber 58, it is subjected to pressure to maintain it in a compacted, pelletised form.

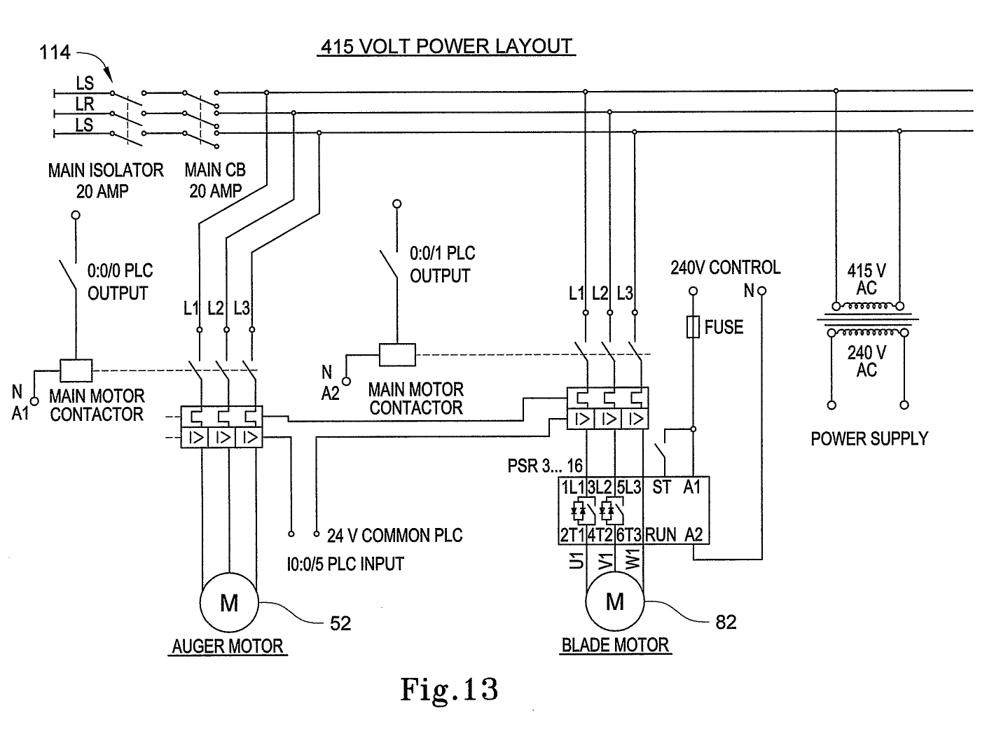

Referring to FIGS. 12 and 13 of the drawings, a control arrangement, or control circuit, of the machine 10 is shown in greater detail. The machine 10 is controlled by a programmable logic controller (PLC) 70.

The access door 16 has an interlock controlled by a door open relay 72. The door open relay 72 is in communication with a switch 74.

The door open relay 72 has a pair of normally open contacts 76. One of the set of normally open contacts 76 is connected to a coil 78 of an auger relay which, in turn, is connected to the auger motor 52. The other of the normally open contacts 76 is connected to a coil 80 of a relay connected to a blade motor 82 which controls rotation of the shafts 26 of the comminuting station 18. An operating indicator in the form of a lamp 84 is associated with the auger relay 78. Similarly, an operating lamp 86 is associated with the blade relay 80. A further operating lamp 88 indicates an over temperature fault and an indicator lamp 90 indicates that the system is operational.

The control circuit further includes a normally open push button switch 92 to start operation of the machine 10 and a normally closed switch 94 to stop operation of the machine 10. There are a pair of switches 96 and 98 associated with alarm conditions to do with over temperature conditions. A normally closed switch 100 is provided for the door 16 and opens when the door 16 is open. A further sensor senses the condition of the feed hopper 14 and, if the feed hopper 14 remains empty for a predetermined period of time, causes the machine 10 to shut down.

The control circuit also includes an emergency stop push button 102 in a power supply 104 of the control circuit. The relay 78 has a pair of normally open contacts 106 connected in the power supply 104 and, similarly, the relay 80 of the blade motor 82 has a pair of normally open contacts 108 mounted in the power supply 104. It is also to be noted that the power supply 104 includes a soft starter 110 for the blade motor 82 to enable a gradual run up in rotational speed of the motor 82.

The power supply has a 24v supply 112 and a 415v supply 114. The 415v supply 114, as shown in FIG. 13 of the drawings, supplies power to the motors 52 and 82.

The machine 10 is intended particularly for use in compacting waste synthetic plastics material. The plastics material in question is an expanded polystyrene (EPS). EPS is used in protecting goods during transportation and, as is well known in the art, comprises sheets or pre-moulded components in which articles to be shipped are contained. EPS is also provided in pellet form and placed about fragile articles in a container in which the articles are placed for postage or shipping.

This EPS, being of a foamed nature, takes up a large volume and causes problems at landfill sites. Another problem is that, due to the lightweight nature of the EPS, it can be blown out of landfill sites creating further pollution. With the provision of the compacting machine 10, these problems are, to a large extent, obviated.

Thus, in use, EPS to be compacted is placed into the feed hopper 14. The access door 16 is closed and the control switch 92 is activated. If the system is operating normally, the material in the feed hopper 14 falls on to the blades 32 of the comminuting elements 30 of the comminuting station 18 and are drawn in between the blades 32. The blades 32 serve to granulate the waste EPS into granules of a predetermined size, more particularly, a size of about 18 mm. Granular parts of the EPS which are larger than this but which pass to the bottom of the comminuting station 18 are swept up by the blades 32 from the upper surface of the filter 44 and are driven by the fingers 36 between the blades 32 for further granulation until granules of a size to pass through the apertures 46 of the filter 44 are formed.

When the machine 10 is started, the auger motor 52 is also started and as the granules fall onto the auger 50, they are driven into the compacting chamber 58 under the action of the auger 50. Because the surface of the flight 54 of the auger 50 is coated with the ceramic material, a low friction surface results and heat generation is minimised. However, a temperature sensor is located in the compacting chamber 58 so that, in an over temperature condition, an alarm sounds, the lamp 88 is energised and the machine 10 is stopped until the problem giving rise to the over temperature condition has been overcome.

Assuming the machine 10 is running normally, the granules are compacted in the compacting chamber 58. In an initial condition, when no material has previously been in the compacting chamber 58, the wing member 60 is in its closed condition. Material driven by the auger 50 into the compacting chamber 58 builds up against the door 60 and is formed into a pelletised block. As the compacting chamber 58 fills with compacted material, the compacted material is urged against the wing member 60. This causes the wing member 60 to rise against the action of the strut 66 until it adopts a partially open position to enable the compacted pelletised block of material to extrude through the open end of the compacting chamber 58. However, because the wing member 60 is not fully open, pressure is still applied on material within the compacting chamber causing it to be further compacted and pelletised.

It is therefore an advantage of the invention that a compacting machine 10 is provided which minimises heat generation. It will be appreciated that EPS melts at a temperature of approximately 70° C. Because the machine operates at significantly lower temperature, the likelihood of melting of the EPS resulting in jamming and gumming up of the machine is reduced. In addition, it is an advantage of the invention that a compacting machine 10 is provided which significantly compacts the EPS so that it adopts a fraction of its previous volume. This also minimises the amount of space occupied by the waste material in waste bins and reduces the likelihood of the waste material being blown away. When compacted, the EPS is fully recyclable and need not go to landfill at all.

The support structure 12 of the machine 10 is mounted on lockable castors 116 so that the machine 10 can be moved from position to position within premises.

The machine 10 compacts the EPS to about 1/50th of its original volume. Not only does this significantly reduce space in landfills but also in premises' own refuse bins. In addition, the fact that the EPS is so reduced in volume makes it easy for it to be collected by recycling operations and transported to recycling plants.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A compacting machine which includes:
a support structure;
a feed hopper carried by the support structure, the feed hopper being configured to receive waste material to be compacted, the feed hopper having a discharge opening;
a comminuting station arranged downstream of, and in communication with, the discharge opening of the feed hopper to comminute material received from the feed hopper into granules of a predetermined size; and
a compacting station arranged downstream of the comminuting station, the compacting zone defining a compacting zone in which granules, discharged from the comminuting station, are compacted and the compacting station further including a compacting member treated to reduce friction and heat generation as the material is compacted in the compacting zone.

2. The machine of claim 1 in which the support structure is in the form of a housing on which the feed hopper is mounted, the housing supporting the comminuting station and the compacting station.

3. The machine of claim 2 in which the housing has an access door for enabling access to be gained to the feed hopper, the access door including an interlock so that the machine is inoperable unless the door is closed.

4. The machine of claim 1 in which the comminuting station comprises a plurality of comminuting elements.

5. The machine of claim 4 in which each comminuting element is in the form of a blade assembly carrying a plurality of arcuate, outwardly extending blades mounted on a boss, each comminuting element being carried on a shaft.

6. The machine of claim 5 in which the comminuting station comprises at least two spaced, counter-rotating shafts, each carrying a plurality of comminuting elements in longitudinally spaced relationship with the comminuting elements of adjacent shafts being interdigitated with respect to each other.

7. The machine of claim 4 in which each comminuting element also carries grabbing members which serve to grab material to be compacted to be drawn into position to be granulated by the comminuting elements.

8. The machine of claim 7 in which the grabbing members are arranged on their associated comminuting elements in staggered relationship relative to one another along the shaft to assist in drawing material into position between the comminuting elements to effect granulation of the material.

9. The machine of claim 4 in which each side wall of the comminuting station includes inwardly directed protrusions to direct material to be granulated into position between the comminuting elements.

10. The machine of claim 1 in which the comminuting station further includes a discriminator which passes granulated material smaller than a predetermined size and retains material in the comminuting station larger than the predetermined size.

11. The machine of claim 1 in which the compacting member comprises a rotary element which rotatably drives material to be compacted into the compacting zone.

12. The machine of claim 11 in which the rotary element is in the form of an auger having a helical flight mounted about a rotatable shaft.

13. The machine of claim 12 in which, at a downstream end of the auger, the flight terminates flush with a downstream end of the shaft.

14. The machine of claims 11 in which the rotary element is coated with a material which reduces friction and minimises heat generation.

15. The machine of claim 14 in which the coating material is a suitable ceramic material.

16. The machine of claim 11 in which the rotary element is arranged upstream of the compacting zone and in which a downstream end of the compacting zone is closed off by a pressure applying member.

17. The machine of claim 1 which includes a control arrangement.

18. The machine of claim 17 in which the control arrangement includes an over temperature sensor.

19. The machine of claim 17 in which the control arrangement includes a sensor for sensing the state of fill of the hopper and to deactivate the operation of the machine if the hopper is empty.

20. An accessory for a compacting machine, the accessory comprising an auger having a helical flight mounted about a rotatable shaft, the flight terminating flush with a downstream end of the shaft.

21. The accessory of claim 20 in which the auger is coated with a material which reduces friction and minimises heat generation.
